(19) United States
(12) Patent Application Publication
(10) Pub. No.: US 2010/0307968 A1
(43) Pub. Date: Dec. 9, 2010

(54) ACTIVATED CARBON WATER FILTER WITH REDUCED LEACHABLE ARSENIC AND METHOD FOR MAKING THE SAME

(75) Inventors: Frank A. Brigano, Northford, CT (US); John H. Schroeder, Mt. Laurel, NJ (US); Vladimir Popovic, Fairfield, CT (US)

Correspondence Address: LAW OFFICE OF DELIO & PETERSON, LLC., 121 WHITNEY AVENUE, NEW HAVEN, CT, 06510, US

(73) Assignee: KX TECHNOLOGIES LLC, Orange, CT (US)

(21) Appl. No.: 12/480,834

(22) Filed: Jun. 9, 2009

(51) Int. Cl. C02F 1/28; B01J 20/20

(52) U.S. Cl. 210/502.1; 502/417

(57) ABSTRACT

An activated carbon filter with reduced leachable arsenic comprising activated carbon, a binder material for binding activated carbon into a filtration mesh and an arsenic adsorbent in a concentration of less than about 5% for reducing leachable arsenic inherent in the activated carbon.

### BACKGROUND OF THE INVENTION

1. Field of the Invention

The present invention relates to activated carbon filters having an additive for reducing the amount of leachable substance inherent in the activated carbon.

2. Description of Related Art

Carbon used in filters is found in various geographical locations with most naturally occurring carbon containing a percentage of arsenic, an element which may be toxic to humans, especially if ingested in high concentrations or in lower concentrations over a long period of time. Carbon, for water filtration is much more effective as a filtration media after it has been activated, either chemically or more conventionally with a steam process in order to increase the porosity of the carbon and therefore the surface area exposed to the water being filtered. However, the activation process increases the arsenic levels leached into the water. The concentration of arsenic in the filtered water is highly affected by the rate of water flow through the carbon media. Water passing through the carbon media at a high flow rate, such as water feeding a household faucet may contain a concentration of arsenic within limits set by the EPA. Water which passes through at a lower flow rate may contain much higher concentrations since the concentration is proportional to the contact time of the water with the carbon. Moreover, as the water sits stagnant in the carbon media for extended lengths of time, the concentration of arsenic may be ten or a hundred times the limit set by the EPA.

There are several chemical compounds that are implemented to reduce the arsenic in the water being filtered. These compounds are added to the carbon media or used concurrently with the carbon media to reduce the arsenic in the water being fed to the filter and are added in high concentrations to be effective for removing the arsenic passing through the filter. The levels in the incoming water are on average very small compared to the arsenic given off by an activated carbon filter with static water flow. Where a carbon filter is used to filter water having concentrations within the limits set by the EPA, these large concentrations of additive are not needed and may take up space more effectively used by other filtration media.

The amount of arsenic contained in activated carbon is extremely variable, as is the leachable fraction that a consumer may be exposed to. Producers of activated carbon have dealt with this by washing the carbon with water or with acid solutions during the production process to strip away the majority of the leachable arsenic. Washing and subsequent drying are expensive processes and add significantly to the cost of carbon production.

Other treatments such as grinding, impregnation or chemical activation may be implemented in carbon production and may cause additional arsenic to be leachable in the final product. These processes may improve certain characteristics of the carbon such as improving contact area and porometry, but add to the leachable arsenic.

Producers of carbon filters have a number of additional problems. The extractable arsenic that a consumer may be exposed to will be dependent not only on the source and treatment of the activated carbon, but also on filter geometry, water-to-carbon ratio, porometry, flow rate and application. Some of the design features that are most desirable, such as compact geometry, high carbon content, tight porometry, and chemical treatments, to name a few, can combine to increase leachable arsenic to dangerous levels.

Currently, activated carbon filter manufacturers have two options at their disposal for dealing with this problem. The first is a compromise between desirable design features and extractable arsenic, the result being a less effective product. The other option is to instruct the consumer to flush the filter for an appropriate length of time. The latter solution relies upon the consumer to follow the instructions without cutting the rinsing process short. This is at best an inconvenience to the consumer and at worst an incentive to use the filter without properly flushing.

In filtering fluids, and specifically in filtering drinking water, arsenic is released from carbon media into the fluid passing through the media. The arsenic is naturally present in carbon media used in filtration. Activated carbon may contain amounts of arsenic which leach into the filtered water at levels beyond those allowed for safe drinking water. While a rapid flow of water through the filter may deliver lower arsenic levels in the filtered water, a slower flow will result in higher arsenic levels. As the flow through the filter approaches zero, the water within the filter media continues to leach arsenic from the media so that when the flow re-starts, the water coming from the filter has a surge in arsenic levels. Particularly, new filters being put into service for the first time may present the highest levels of arsenic and need to be thoroughly flushed to eliminate the initial surge of arsenic.

The present invention is particularly useful for providing a level of protection from arsenic in filters that are not conveniently flushable, or for reducing cost for pre-flushing filters that previously needed to be acid washed by allowing water flushing.

### SUMMARY OF THE INVENTION

Bearing in mind the problems and deficiencies of the prior art, it is therefore an object of the present invention to provide a carbon filters having an additive for reducing the amount of leachable substance inherent in the activated carbon

It is another object of the present invention to provide a carbon filter which reduces the leachable arsenic from the media of the filter.

A further object of the invention is to provide a carbon filter media containing less than about 5% titanium dioxide for reducing the leachable arsenic from the media of the filter.

It is another object of the present invention to adsorb the arsenic given off by the carbon to prevent arsenic surges during low or no water flow conditions.

It is yet another object of the present invention to provide a carbon filter media containing less than about 5% alumina for reducing the leachable arsenic from the media of the filter.

It is still another object of the present invention to provide a carbon filter media containing less than about 5% zirconium hydroxide for reducing the leachable arsenic from the media of the filter.

It is another object of the present invention to provide a carbon filter media containing less than about 5% aluminum oxide and manganese oxide for reducing the leachable arsenic from the media of the filter.

It is another object of the present invention to provide a carbon filter media containing less than about 5% diatomaceous earth for reducing the leachable arsenic from the media of the filter.

It is another object of the present invention to provide a carbon filter media containing less than about 5% ion exchange media for reducing the leachable arsenic from the media of the filter.

Still other objects and advantages of the invention will in part be obvious and will in part be apparent from the specification.

The above and other objects, which will be apparent to those skilled in the art, are achieved in the present invention which is directed to an activated carbon filter media containing less than about 5% arsenic adsorbent for reducing arsenic leachable into fluid passing therethrough. The arsenic adsorbent preferably includes at least one of the following; titanium dioxide, alumina, zirconium hydroxide, aluminum oxide, manganese oxide, diatomaceous earth, ion exchange media. The activated carbon media is preferably granular. The activated carbon filter media may contain about 2% arsenic adsorbent

Another aspect of the invention is directed to a water filter with reduced leachable arsenic comprising activated carbon, a binder material for binding activated carbon into a filtration mesh, typically called a block, and an arsenic adsorbent in a concentration of less than about 5% for reducing leachable arsenic inherent in the activated carbon. The arsenic adsorbent preferably includes at least one of the following; titanium dioxide, alumina, zirconium hydroxide, aluminum oxide, manganese oxide, diatomaceous earth, ion exchange media. The activated carbon is preferably granular. The activated carbon may contain about 2% arsenic adsorbent.

Another aspect of the invention is directed to a process for making an activated carbon filter media with reduced leachable arsenic comprising providing an activated carbon media, providing an arsenic adsorbent, and combining the arsenic adsorbent with the activated carbon media in a concentration of less than about 5% arsenic adsorbent. The arsenic adsorbent preferably includes at least one of the following; titanium dioxide, alumina, zirconium hydroxide, aluminum oxide, manganese oxide, diatomaceous earth, ion exchange media. The activated carbon media is preferably granular. The activated carbon filter media may contain about 2% arsenic adsorbent

Another aspect of the invention is directed to an activated carbon filter media containing up to about 5% arsenic adsorbent for reducing arsenic leachable into fluid passing therethrough. The invention is additionally directed to a process for making an activated carbon filter media with reduced leachable arsenic comprising providing an activated carbon media, providing an arsenic adsorbent, and combining the arsenic adsorbent with the activated carbon media in a concentration of up to about 5% arsenic adsorbent.

Another aspect of the invention is directed to a water filter with reduced leachable arsenic comprising activated carbon, a binder material for binding activated carbon into a filtration mesh and arsenic adsorbent in a concentration of less than about 5% for reducing leachable arsenic inherent in the activated carbon.

Another aspect of the invention is directed to an activated carbon filter media containing activated carbon and a concentration of arsenic adsorbent sufficient only for reducing arsenic leachable from the activated carbon into water having extended contact time with said filter media due to low or no flow conditions. The concentration of arsenic adsorbent is sufficiently low to have negligible adsorption of arsenic in the water flowing through the filter. Preferably, the concentration of arsenic adsorbent is less than about 5%.

### DESCRIPTION OF THE PREFERRED EMBODIMENT(s)

The present invention is a carbon media containing an additive in concentrations of less than about 5% for reducing arsenic given off by the filter. Carbon filter with this lower concentration of additive are not able to significantly reduce arsenic in the incoming water. The purpose of these lower concentrations are solely to reduce the leachable arsenic in the carbon at slow or no flow rate conditions.

The preferred embodiment includes an additive to the filter media which adsorbs arsenic given off by the carbon media. Since the adsorption of arsenic from the carbon into the additive is gradual, the additive adsorbs the arsenic in amounts proportional to the arsenic levels adsorbed into the water from the carbon. The water contacting the media in the filter for long periods of time during periods of non-use will not contain the high arsenic levels when water begins to flow.

The arsenic adsorbent may be composed of one or more of the following:
Ferric Oxide media
Iron/diatomaceous earth
Activated Alumina
Iron-enhanced Activated Alumina
Iron Complex media
Aluminum oxide
Manganese oxide
Aluminum hydroxide
Manganese hydroxide
Ferric Hydroxide media
Zirconium Hydroxide
Zirconium Oxide
Iron adsorption/Base Ion exchange media
Zeolite media
Titanium Dioxide media

One specific form of titanium dioxide is the chemical with the trademark name “Metsorb™” and is the preferred additive for the extruded carbon block. Metsorb™ has been conclusively found to substantially reduce the arsenic and it is currently favored as the additive of choice.

The present invention provides for low concentration of adsorbent relative to the carbon content. Typically, filters having arsenic adsorbing media contain large amounts of adsorbent for removing arsenic in the water to be filtered. The present invention adsorbs the arsenic given off by the carbon to prevent arsenic surges during low or no water flow conditions. Concentrations of the adsorbent effective for this purpose are typically in the range of 5% or less, which is much less than that required to remove arsenic from water. Additionally, this filter reduces the amount of flush time needed to safely put the filter into service.

### EXAMPLES

Prototype carbon-block filters were prepared containing carbon and binder only, and an identical set was made using carbon, binder and 2% Metsorb™ HMRP 50 micron. The samples were tested for extractable arsenic by the NSF 42 method using flush times, but only the first 24 hour sample was analyzed. The EPA limit for arsenic in drinking water is 10 ppb - 5 ppb in some states. The following test results were achieved:

Extractable Arsenic (ppb)

| Flush time (minutes) | with Metsorb ™ | without Metsorb ™ |
|---|---|---|
| 0 | 1.7 | 20.0 |
| 30 | 1.0 | 17.5 |
| 60 | 1.5 | 15.5 |

The results from testing performed as shown in the table above, illustrate that the titanium dioxide media Metsorb™, even at low concentrations, substantially reduces extractable arsenic in carbon filters to a level below the EPA maximum limits for arsenic in drinking water.

The concentration of arsenic adsorbent in the activated carbon filter media is sufficient only for reducing arsenic leachable from the activated carbon into the water when the water has extended contact time with the filter media. Extended contact time is established when water ceases to flow through the filter or water flow is reduced substantially below the normal working flow rate range set for the filter. The working flow rate is usually set by the ability for the activated carbon to remove contaminants below specific industry standards.

One of the advantages of using a low concentration of arsenic adsorbent is that the adsorbent does not displace a great amount of activated carbon. Large amounts of additives to carbon reduce the amount of activated carbon in the filter, reducing the throughput of the filter or requiring a larger filter for a given throughput. By limiting the arsenic adsorbent to less than about 5%, the contaminant removal by the activated carbon is left substantially intact. In many cases, the source water contains arsenic a range allowable by the EPA. Only the arsenic leachable into the product water during no flow or low flow conditions spike the arsenic levels beyond those set by the EPA. Therefore, adding a large amount of arsenic adsorbent to remove arsenic in the product water may be left to other filtration products necessary for those specific conditions.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. An activated carbon filter media containing activated carbon having a concentration of arsenic and an effective amount of arsenic adsorbent sufficient only for reducing said concentration of arsenic leachable from the activated carbon into fluid passing therethrough at slow or no flow rate conditions, said effective amount of arsenic adsorbent less than about 5% concentration.

2. The activated carbon filter media of claim 1 wherein the activated carbon filter media contains about 2% arsenic adsorbent.

3. The activated carbon media of claim 1 wherein the arsenic adsorbent includes titanium dioxide.

4. The activated carbon media of claim 1 wherein the arsenic adsorbent includes alumina.

5. The activated carbon media of claim 1 wherein the arsenic adsorbent includes zirconium hydroxide.

6. The activated carbon media of claim 1 wherein the arsenic adsorbent includes aluminum oxide and manganese oxide.

7. The activated carbon media of claim 1 wherein the arsenic adsorbent includes diatomaceous earth.

8. The activated carbon media of claim 1 wherein the arsenic adsorbent includes an ion exchange media.

9. The activated carbon media of claim 1 wherein the carbon media is granular.

10. A water filter with reduced leachable arsenic comprising:
activated carbon having a concentration of arsenic contained therein;
binder material for binding activated carbon into a filtration mesh; and
arsenic adsorbent in a concentration sufficient only for reducing leachable arsenic inherent in the activated carbon at slow or no flow rate conditions, and less than about 5% concentration.

11. The water filter of claim 10 wherein the water filter contains about 2% arsenic adsorbent.

12. The water filter of claim 10 wherein the arsenic adsorbent includes titanium dioxide.

13. The water filter of claim 10 wherein the arsenic absorbent includes alumina.

14. The water filter of claim 10 wherein the arsenic adsorbent includes zirconium hydroxide.

15. The water filter of claim 10 wherein the arsenic adsorbent includes aluminum oxide and manganese oxide.

16. A process for making an activated carbon filter media with reduced leachable arsenic comprising:
providing an activated carbon media;
providing an arsenic adsorbent; and
combining the arsenic adsorbent with the activated carbon media in a concentration of less than about 5% arsenic adsorbent.

17. The process of claim 16 wherein the activated carbon filter media contains about 2% arsenic adsorbent.

18. The process of claim 16 wherein the arsenic adsorbent includes titanium dioxide.

19. The process of claim 16 wherein the arsenic absorbent includes alumina.

20. The process of claim 16 wherein the arsenic adsorbent includes zirconium hydroxide.

21. An activated carbon filter media containing activated carbon having a concentration of arsenic contained therein, and a concentration of arsenic adsorbent sufficient only for reducing said arsenic contained within the activated carbon and leachable from the activated carbon into water having extended contact time with the filter media due to low or no flow conditions and sufficiently low concentration of arsenic adsorbent to have negligible adsorption of arsenic in the water flowing through the filter.

22. The activated carbon filter media of claim 21 wherein the activated carbon filter media contains less than about 5% arsenic adsorbent.

23. The activated carbon filter media of claim 21 wherein the activated carbon filter media contains about 2% arsenic adsorbent.
